(19) United States
(12) Patent Application Publication
(10) Pub. No.: US 2013/0038922 A1
(43) Pub. Date: Feb. 14, 2013

(54) OPTICAL ELEMENT, OPTICAL ELEMENT ARRAY, DISPLAY DEVICE, AND ELECTRONIC APPARATUS

(71) Applicant: Shina Kirita, Tokyo (JP)

(72) Inventor: Shina Kirita, Tokyo (JP)

(73) Assignee: Sony Corporation, Tokyo (JP)

(21) Appl. No.: 13/565,037

(22) Filed: Aug. 2, 2012

(30) Foreign Application Priority Data
Aug. 9, 2011 (JP) 2011-173781

(51) Int. Cl. G02F 1/29

(52) U.S. Cl. 359/316; 359/315

(57) ABSTRACT

Disclosed is an optical element including a first electrode and a second electrode disposed to face each other; an insulating film covering a surface of the first electrode facing the second electrode, the insulating film including a dielectric layer, an ion barrier layer, and a water repellent layer laminated in order; and a polar liquid and a non-polar liquid enclosed between the insulating film and the second electrode and having refractive indices different from each other. The dielectric layer has a larger permittivity than that of the ion barrier layer, the ion barrier layer suppresses permeation of an ion contained in the polar liquid, and the water repellent layer is located in an uppermost layer of the insulating film and exhibits an affinity for the non-polar liquid.

### BACKGROUND

The present disclosure relates to an optical element and an optical element array each utilizing an electrowetting phenomenon, a display device including the optical element array, and an electronic apparatus including the display device.

Heretofore, a liquid optical element has been developed which exercises an optical operation by electrowetting (electrocapillary phenomenon). Electrowetting is a phenomenon in which when a voltage is applied across an electrode and a conductive liquid (polar liquid), the interfacial energy between the electrode surface and the polar liquid changes, and therefore the surface shape of the polar liquid changes.

The applicant of this patent application has previously proposed a stereoscopic image display device including a lenticular lens constituted by a plurality of liquid optical elements that utilize electrowetting. Such stereoscopic image display device is described in, for example, Japanese Patent Laid-open No. 2009-247480.

### SUMMARY

In general, since electrowetting is utilized in liquid optical elements, the surface of the electrode is covered with a water repellent insulating film. The water repellent insulating film is required to be one that ensures a desired insulating property (sufficiently suppress leakage current) and forms a desired contact angle with the polar liquid.

In addition, recently, driving with a lower applied voltage is desired for such liquid optical elements. In order to attain this, there are considered two points: increasing the permittivity of the insulating film and reducing the thickness of the insulating film.

The present disclosure has been made taking into consideration the above points, and it is therefore desirable to provide an optical element and an optical array that are capable of satisfactorily operating even with a lower voltage while ensuring a sufficient insulating property, and a display device including the optical element array, and an electronic apparatus including the display device.

An optical element according to an embodiment of the present disclosure includes: a first electrode and a second electrode disposed so as to face each other; an insulating film covering a surface of the first electrode facing the second electrode, the insulating film including a dielectric layer, an ion barrier layer, and a water repellent layer laminated in order; and a polar liquid and a non-polar liquid enclosed between the insulating film and the second electrode and having refractive indices different from each other. The dielectric layer has a larger permittivity than that of the ion barrier layer, the ion barrier layer suppresses permeation of an ion contained in the polar liquid, and the water repellent layer is located in an uppermost layer of the insulating film and exhibits an affinity for the non-polar liquid.

An optical element array according to another embodiment of the present disclosure includes: a first substrate and a second substrate disposed so as to face each other; a partition wall erected on an inner surface of the first substrate facing the second substrate, the partition wall partitioning a region over the first substrate into plural cell regions; a first electrode and a second electrode disposed in each of the plural cell regions on wall surfaces of the partition wall, respectively, so as to face each other; an insulating film covering the first electrode and the second electrode, the insulating film including a dielectric layer, an ion barrier layer, and a water repellent layer laminated in order; a third electrode provided on an inner surface of the second substrate facing the first substrate; and a polar liquid and a non-polar liquid enclosed between the first substrate and the third electrode and having refractive indices different from each other. The dielectric layer has a larger permittivity than that of the ion barrier layer, the ion barrier layer suppresses permeation of an ion contained in the polar liquid, and the water repellent layer exhibits an affinity for the non-polar liquid.

A display device according to still another embodiment includes a display section and an optical element array, the optical element array including: a first substrate and a second substrate disposed so as to face each other; a partition wall erected on an inner surface of the first substrate facing the second substrate, the partition wall partitioning a region over the first substrate into plural cell regions; a first electrode and a second electrode disposed in each of the plural cell regions on wall surfaces of the partition wall, respectively, so as to face each other; an insulating film covering the first electrode and the second electrode, the insulating film including a dielectric layer, an ion barrier layer, and a water repellent layer laminated in order; a third electrode provided on an inner surface of the second substrate facing the first substrate; and a polar liquid and a non-polar liquid enclosed between the first substrate and the third electrode and having refractive indices different from each other, wherein the dielectric layer has a larger permittivity than that of the ion barrier layer, the ion barrier layer suppresses permeation of an ion contained in the polar liquid, and the water repellent layer exhibits an affinity for the non-polar liquid.

An electronic apparatus according to yet another embodiment includes a display device having a display section and an optical element array, the optical element array including: a first substrate and a second substrate disposed so as to face each other; a partition wall erected on an inner surface of the first substrate facing the second substrate, the partition wall partitioning a region over the first substrate into plural cell regions; a first electrode and a second electrode disposed in each of the plural cell regions on wall surfaces of the partition wall, respectively, so as to face each other; an insulating film covering the first electrode and the second electrode, the insulating film including a dielectric layer, an ion barrier layer, and a water repellent layer laminated in order; a third electrode provided on an inner surface of the second substrate facing the first substrate; and a polar liquid and a non-polar liquid enclosed between the first substrate and the third electrode and having refractive indices different from each other, wherein the dielectric layer has a larger permittivity than that of the ion barrier layer, the ion barrier layer suppresses permeation of an ion contained in the polar liquid, and the water repellent layer exhibits an affinity for the non-polar liquid.

Here, the display section is, for example, a display that has plural pixels and produces a two-dimensional display image corresponding to a video signal.

In the optical element, the optical element array, the display device, and the electronic apparatus according to the respective embodiments of the present disclosure, the insulating film includes the dielectric layer, the ion barrier layer, and the water repellent layer laminated in order. As a result, the dielectric breakdown voltage of the insulating film is increased, and the contact angle of the non-polar liquid with the insulating film is stably changed with application of a lower voltage. That is to say, the shape of the interface between the polar liquid and the non-polar liquid can be controlled with a lower voltage while avoiding dielectric breakdown of the insulating film.

As set forth above, according to embodiments of the present disclosure, in the optical element and the optical element array, the first electrode (or the first electrode and the second electrode) is(are) covered with the insulating film in which the dielectric layer, the ion barrier layer, and the water repellent layer are laminated in this order. Therefore, precise driving with a lower voltage can be realized while ensuring a sufficient insulating property. For this reason, in the display device including the optical element array, and in the electronic apparatus including the display device, precise image display corresponding to a given video signal can be realized with reduced power consumption.

### BRIEF DESCRIPTION OF THE DRAWINGS

FIGS. 1A and 1B are cross sectional views of a liquid optical element according to a first embodiment of the present disclosure, FIG. 1A showing a state where no voltage is applied and FIG. 1B showing a state where a voltage is being applied;

FIG. 2 is an enlarged cross sectional view showing a structure of an insulating film shown in FIGS. 1A and 1B;

FIG. 3 is a cross sectional view showing a structure of a liquid optical element array according to a second embodiment of the present disclosure;

FIG. 4 is a top plan view showing the entire structure of the liquid optical element array shown in FIG. 3;

FIGS. 5A and 5B are schematic views explaining an operation of the liquid optical element array shown in FIG. 3;

FIG. 6 is a schematic view showing the entire configuration of a stereoscopic display device as a third embodiment of the present disclosure;

FIG. 7 is a cross sectional view showing a structure of a main portion of a wave-front conversion-deflecting unit shown in FIG. 6;

FIG. 8 is a cross sectional view taken along line VIII-VIII of FIG. 7;

FIG. 9 is a cross sectional view taken along line IX-IX of FIG. 7;

FIGS. 10A, 10B, and 10C are conceptual views explaining operations of the liquid optical element shown in FIG. 8;

FIGS. 11A and 11B are different conceptual views explaining operations of the liquid optical element shown in FIG. 8;

FIGS. 12, 13, and 14 are respectively schematic cross sectional views explaining processes in a method of manufacturing the wave-front conversion-deflecting unit shown in FIG. 6;

FIG. 15 is a perspective view showing a configuration of a television apparatus as Example of Application of an electronic apparatus according to a fourth embodiment of the present disclosure using the display device according to the third embodiment;

FIG. 16 is a schematic cross sectional view explaining a structure of samples used as Examples of Experiment;

FIG. 17 is a graph representing relationships between applied voltage and leakage current in Examples 1 to 3 of Experiment;

FIG. 18 is a graph representing relationships between applied voltage and contact angle in Examples 4 to 7 of Experiment; and

FIG. 19 is a cross sectional view explaining another use example of the wave-front conversion-deflecting unit shown in FIG. 6.

### DETAILED DESCRIPTION OF THE PREFERRED EMBODIMENTS

Embodiments of the present disclosure will be described in detail hereinafter with reference to the accompanying drawings. It is noted that the description will be given below in the following order.

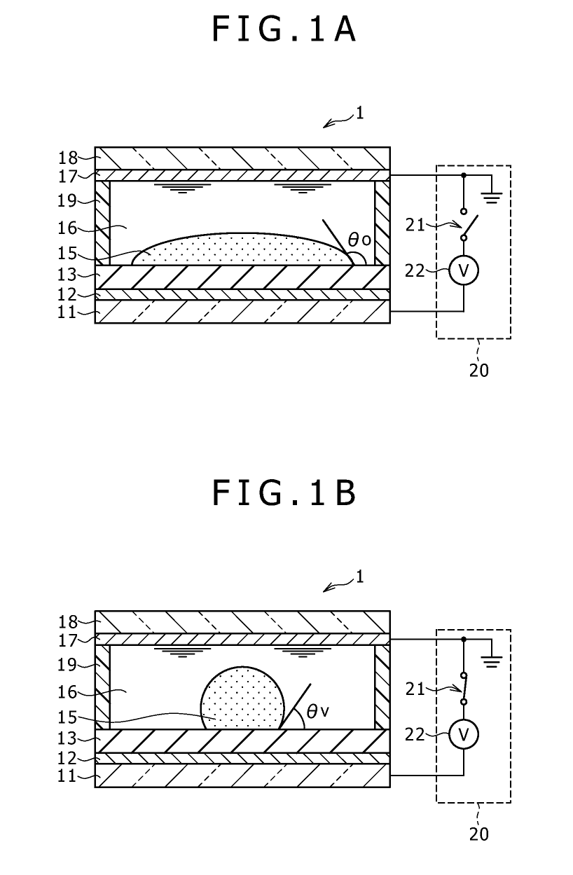

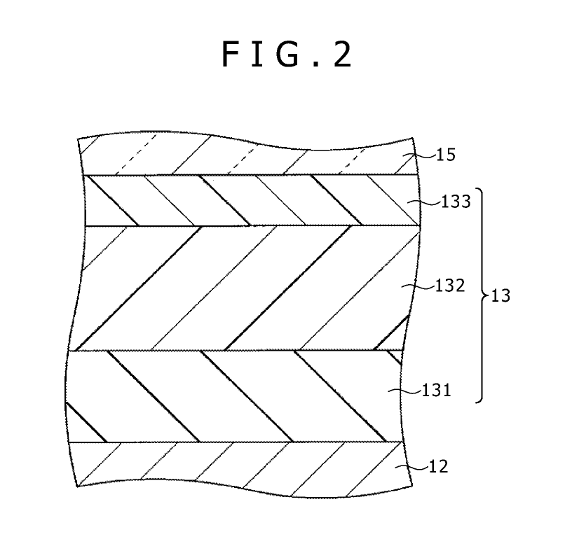

1. First Embodiment (FIGS. 1A and 1B, and FIG. 2): Liquid Optical Element

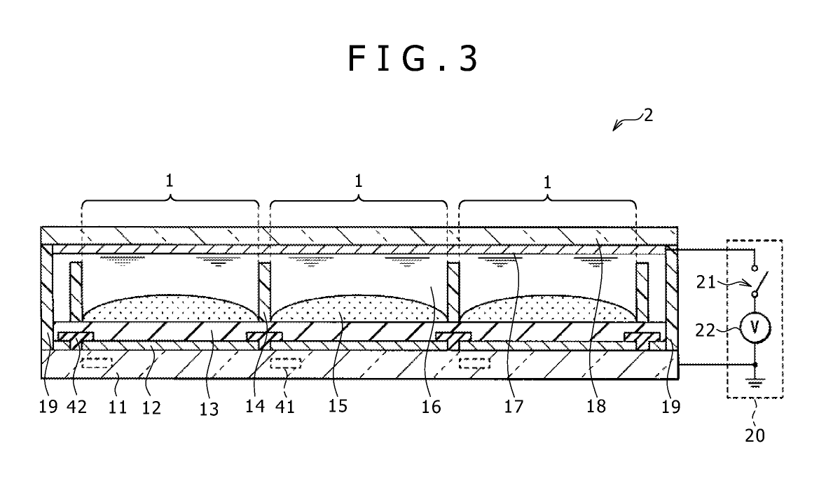

2. Second Embodiment (FIGS. 3 to FIGS. 5A and 5B): Liquid Crystal Element Array

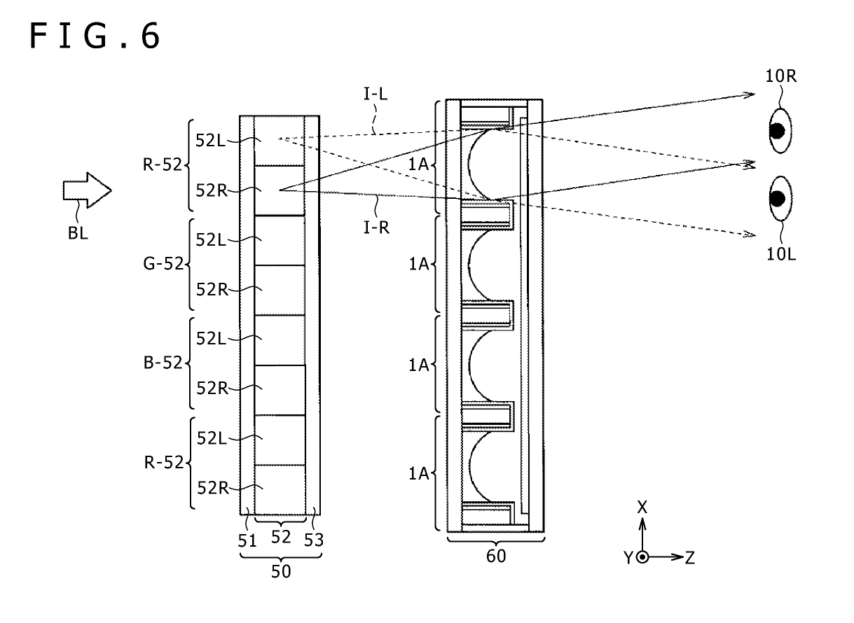

3. Third Embodiment (FIGS. 6 to 14): Stereoscopic Display Device

4. Fourth Embodiment: Electronic Apparatus

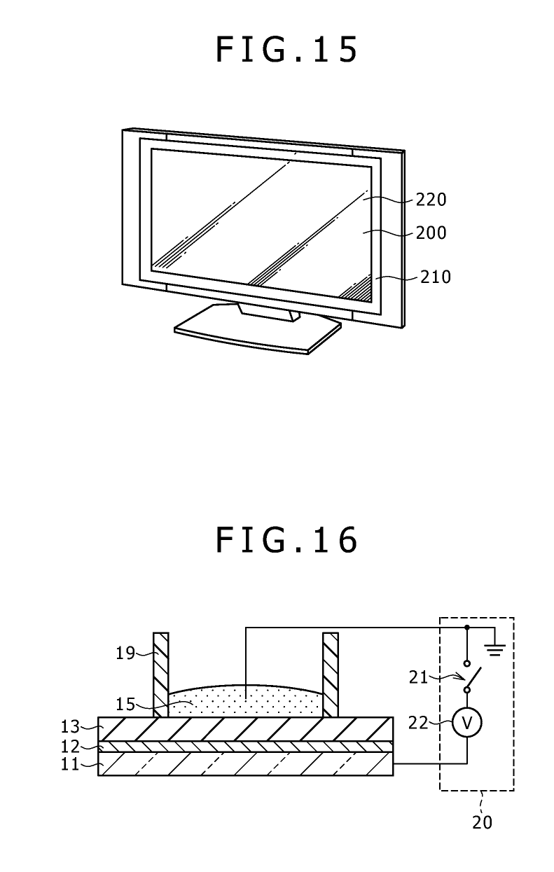

5. Examples of Application (FIG. 15): Examples of Application of Display Device

6. Examples of Experiment

### 1. FIRST EMBODIMENT

### Liquid Optical Element

### <Structure of Liquid Optical Element>

FIGS. 1A and 1B are cross sectional views showing the entire structure of a liquid optical element 1 as a first embodiment of the present disclosure. The liquid optical element 1 is an electrowetting element that carries out optical control on light transmitting therethrough by the so-called electrowetting phenomenon. Specifically, the liquid optical element 1 is connected to a control section 20, and it controls electrostatic wettability so as to deform or change a shape of an interface between a non-polar liquid 15 and a polar liquid 16 contained in the liquid optical element 1, thereby exerting an optical operation on the transmitted light. FIG. 1A shows a state in which no voltage is applied across a lower electrode 12 and an upper electrode 17 facing each other (V=0), and FIG. 1B shows a state in which a voltage V having a predetermined magnitude is applied across the lower electrode 12 and the upper electrode 17 facing each other (V>0). An operation of the liquid optical element 1 will be described in detail later.

The liquid optical element 1 includes a lower substrate 11, the lower electrode 12 covering the lower substrate 11, an insulating film 13 covering the lower electrode 12, a sidewall 19 erected along the outer edges of the insulating film 13, the upper electrode 17, and an upper substrate 18 in order. Both of the non-polar liquid 15 and the polar liquid 16 are enclosed within the space surrounded by the insulating film 13, the sidewall 19, and the upper electrode 17. On the other hand, the control section 20 includes a switch portion 21 and a power source 22. Both of the lower electrode 12 and the upper electrode 17 are connected to the power source 22 so that a voltage can be applied between the electrodes. Incidentally, the upper electrode 17 may be grounded.

The lower substrate 11 and the upper substrate 18 are supported by the sidewall 19 and are disposed so as to face each other. Also, each of the lower substrate 11 and the upper substrate 18, for example, is made of a transparent insulating material, such as glass or a transparent plastic, which transmits visible light. It is noted that the insulating film 13 in the first embodiment can be deposited at a temperature of 100° C. or less. Therefore, the lower substrate 11 can be a transparent resin substrate containing at least one kind of material selected from the group consisting of polycarbonate (PC), polyethylene terephthalate (PET), polyethylene naphthalate (PEN), polyethersulphone (PES), and polyolefin (PO).

Each of the lower electrode 12 and the upper electrode 17, for example, is made of a transparent conductive material such as an indium tin oxide (ITO) or a zinc oxide (ZnO).

FIG. 2 is a cross sectional view showing an enlarged cross-sectional structure of a portion of the insulating film 13. The insulating film 13, as shown in FIG. 2, includes a dielectric layer 131, an ion barrier layer 132, and a water repellent layer 133 which are laminated in order from the side of the lower electrode 12. The dielectric layer 131 has a larger permittivity than that of the ion barrier layer 132 and for example, is made of a material containing at least one kind of material selected from the group consisting of Al₂O₃, Ta₂O₅, ZrO₂, ZnO₂, TiO₂, MgO, and HfO₂. The dielectric layer 131 is finely formed by, for example, using the atomic layer deposition (ALD) method, the sputtering method, or the chemical vapor deposition (CVD) method.

The ion barrier layer 132 serves to suppress the permeation of ions contained in the polar liquid 16 and is made of a material containing polymer having a para-xylylene skeleton as a repeating unit. More specifically, the ion barrier layer 132, for example, is made of parylene N expressed by the chemical formula (1), parylene C expressed by the chemical formula (2), parylene D expressed by the chemical formula (3) or parylene HT expressed by the chemical formula (4):

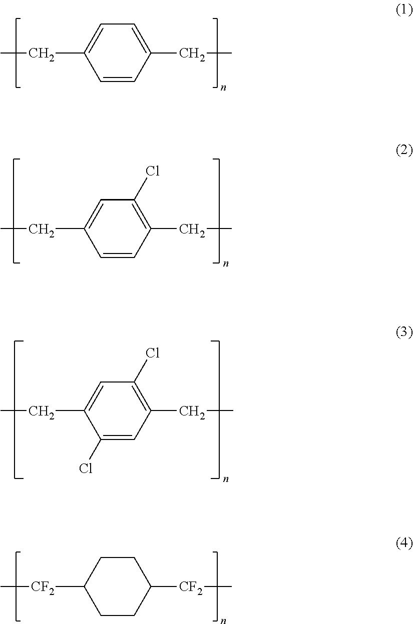

The water repellent layer 133 is made of a material which exhibits a water-repellent property (hydrophobic property) for the polar liquid 16 (more strictly, exhibits an affinity for the non-polar liquid 15 rather than for the polar liquid 16 under non-electric field), and has an excellent electric insulating property. Specifically, the material for the water repellent layer 133 includes poly(vinyliden fluoride) (PVdF) or polytetrafluoroethylene (PTFE) as fluorine system polymer.

The non-polar liquid 15 is a liquid material which hardly has a polarity and exhibits an electric insulating property. For example, a hydrocarbon system material such as decane, dodecane, hexadecane, or undecane, silicon oil or the like is preferable for the non-polar liquid 15. When a voltage is applied to the non-polar liquid 15, direct influence of the voltage application hardly exerts on its wettability with respect to the insulating film 13. The non-polar liquid 15 preferably has a volume sufficient to cover a desired area of the surface of the insulating film 13 when no voltage is applied across the lower electrode 12 and the upper electrode 17.

On the other hand, the polar liquid 16 is a liquid material having a polarity. Examples of liquids that can be used as the polar liquid 16 are water or a solution in which an electrolyte such as potassium chloride, sodium chloride or lithium chloride is dissolved. When a voltage is applied to the polar liquid 16, its wettability for the insulating film 13 (a contact angle between the non-polar liquid 15 and the insulating film 13) is relatively largely changed.

The non-polar liquid 15 and the polar liquid 16, which are both enclosed between the insulating film 13 and the upper electrode 17, are separated from each other without being mixed and form two layers. In the first embodiment, the non-polar liquid 15 and the polar liquid 16 are both transparent.

The sidewall 19 seals, together with the lower substrate 11 and the upper substrate 18, both of the non-polar liquid 15 and the polar liquid 16. The sidewall 19 may be made of the same kind of material as that of the lower substrate 11 and the upper substrate 18.

The control section 20 carries out driving control of the liquid optical element 1. One terminal of the switch 21 is connected to the upper electrode 17 with a metallic wiring, and the other terminal thereof is connected to the lower electrode 12 through the power source 22 with a metallic wiring. The switch 21 can select between two states: an ON state in which the opposite two terminals of the switch 21 are electrically connected to each other; and an OFF state in which the opposite two terminals of the switch 21 are electrically disconnected from each other. The power source 22 can change the magnitude of the voltage within a predetermined range, and can also arbitrarily set the magnitude of the voltage. Therefore, the control section is adapted to apply a predetermined voltage across the lower electrode 12 and the upper electrode 17 in accordance with both of a manipulation for the switch 21 (a manipulation for selecting between the ON state and the OFF state), and the voltage control for the power source 22.

### <Operation of Liquid Optical Element>

Next, a description will be given with respect to an operation of the liquid optical element 1 configured in the manner described above.

Firstly, a description will be given of the principles of electrowetting with reference to FIGS. 1A and 1B. Electrowetting is a phenomenon in which when a suitable voltage is applied across a conductive liquid and an electrode, the solid-liquid interfacial energy between the surface of the electrode and the liquid changes, so that the shape of the surface of the liquid changes. FIGS. 1A and 1B are schematic views explaining the electrowetting phenomenon. As shown in FIG. 1A, in the state in which no voltage is applied across the lower electrode 12 and the upper electrode 17, the interaction energy between the surface of the insulating film 13 and the non-polar liquid 15 is low, and thus a contact angle θ₀ is large. Here, the contact angle θ₀ is an angle between the surface of the insulating film 13 and a positive tangent line of the non-polar liquid 15, and its magnitude depends on the physical properties such as a surface tension of the non-polar liquid 15, and a surface energy of the insulating film 13. On the other hand, as shown in FIG. 1B, when a voltage is applied across the lower electrode 12 and the upper electrode 17, electrolyte ions in the polar liquid 16 concentrate in the vicinity of the surface of the insulating film 13 to cause a change in the charging amount, thereby inducing a change in the surface tension of the non-polar liquid 15. This phenomenon is the electrowetting phenomenon, and thus a contact angle θv of the non-polar liquid 15 changes depending on the magnitude of the applied voltage. That is to say, in FIG. 1B, the contact angle θv is expressed by Expression (1), i.e., the Lippman-Young equation, which is a function of an applied voltage V:

cos(θv)=cos(θ₀)+(∈₀×∈×V²)/(2×γ×t) (1)

where ∈₀ is a permittivity of a vacuum, ∈ is a relative permittivity of the insulating film 13, γ is a surface tension between the non-polar liquid 15 and the polar liquid 16, and t is a thickness of the insulating film 13.

As described above, the shape (curvature) of the interface between the non-polar liquid 15 and the polar liquid 16 changes depending on the magnitude of the voltage V applied across the lower electrode 12 and the upper electrode 17. Therefore, when the non-polar liquid 15 is used as a lens element, it is possible to realize an optical element with which a focal position (focal length) can be electrically controlled.

### <Effects of Liquid Optical Element>

In such a manner, in the liquid optical element 1 of the first embodiment, of the lower electrode 12 and the upper electrode 17 disposed so as to face each other and contain therebetween the non-polar liquid 15 and the polar liquid 16, the lower electrode is covered with the insulating film 13 having the three-layer structure. Since the insulating film 13 includes the dielectric layer 131 as the layer closest to the lower electrode 12, high insulating resistance can be ensured. In addition, since the ion barrier layer 132 is provided so as to cover the dielectric layer 131, the permeation of the polar liquid 16 as the electrolysis solution into the dielectric layer 131 is avoided. For this reason, the dielectric breakdown voltage of the insulating film 13 can be increased while the entire thickness of the insulating film 13 is reduced. In addition, since the water repellent layer 133 is provided in the uppermost layer, the initial contact angle θ₀ of the non-polar liquid 15 can be stabilized and the interface shape can be reproducibly controlled in accordance with the applied voltage V. As a result, the liquid optical element 1 can be driven by a suppressed driving voltage of, for example, 30 V or less due to the thinning of the insulating film 13 while ensuring sufficient insulating property, and also stable changing of the interface shape can be precisely reproduced.

It is noted that the insulating film 13 is not limited in structure to the three-layer structure composed of the dielectric layer 131, the ion barrier layer 132, and the water repellent layer 133. It may also adopt a structure in which any other suitable layer(s) is(are) added to the three-layer structure. However, preferably, the water repellent layer 133 is provided in the uppermost layer which contacts with the non-polar liquid 15 and the polar liquid 16.

### 2. SECOND EMBODIMENT

### Liquid Optical Element Array

### <Configuration of Liquid Optical Element Array>

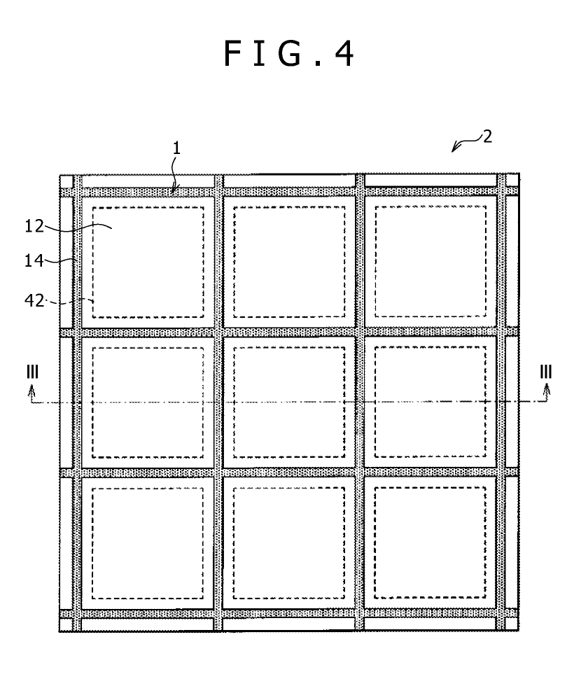

FIG. 3 is a cross sectional view showing the entire structure of a liquid optical element array 2 according to a second embodiment of the present disclosure. FIG. 4 is a top plan view showing the entire structure of the liquid optical element array 2 according to the second embodiment of the present disclosure. Note that, FIG. 3 is a cross sectional view taken along line III-III of FIG. 4. In addition, an illustration of the constituent elements such as the insulating film 13, the non-polar liquid 15, the polar liquid 16, the upper electrode 17, the upper substrate 18, and the sidewall 19 is omitted in FIG. 4 for the sake of convenience. The liquid optical element array 2 is constituted by a plurality of the liquid optical elements 1, described in the first embodiment, disposed in an array. It is noted that although nine liquid optical elements 1 are shown in FIG. 4, the number of liquid optical elements 1 is by no means limited to nine. As shown in FIG. 4, each of the nine liquid optical elements 1, for example, has a square in top-plan shape. Each of the liquid optical elements 1 is an electrowetting element connected to the control section 20, and causes deformation and displacement of the polar liquid 16 contained therein by controlling its electrostatic wettability, thereby controlling a quantity of light transmitted therethrough in accordance with this phenomenon. In the second embodiment, constituent elements that are substantially the same as those described in the first embodiment are designated by the same reference numerals or symbols, respectively, and a description thereof is suitably omitted here for the sake of simplicity.

A driving element 41 such as a thin film transistor is provided in the lower substrate 11 for every liquid optical element 1. Also, signal line pairs (not shown) composed of gate lines, data lines, and the like which are connected to the control section 20 in order to individually drive these driving elements 41 are provided in the lower substrate 11. It is noted that the driving elements 41 and the signal line pairs may be provided on a substrate different from the lower substrate 11.

The lower electrode 12 is connected to one terminal of the driving element 41, and the upper electrode 17 is held at a given electric potential. That is to say, a suitable voltage is applied across the lower electrode 12 and the upper electrode 17 of every liquid optical element 1 by the control section 20, whereby a transmission quantity of incident light from the outside can be controlled for every liquid optical element 1. The lower electrode 12 is divided into plural parts to be disposed so as to correspond to the liquid optical elements 1, respectively. The plural parts of the lower electrode 12 are insulated from one another by light blocking members 42. Preferably, the lower electrodes 12 extend over the entire surface of the respective liquid optical elements 1, and a portion thereof (outer edges of the lower electrodes 12) is covered with the light blocking members 42.

The light blocking member 42 is provided at each of the boundary portions among the plural liquid optical elements 1 and is made of an insulating material containing therein a pigment or dye, such as carbon black, that absorbs light of a predetermined wavelength (for example, visible light). Thus, the light blocking member 42 functions as a so-called black matrix having a light blocking property.

The plural liquid optical elements 1 are partitioned off one another by the partition walls 14. That is to say, the partition walls 14 are partitioning members for demarcating the liquid optical elements 1 into individual unit regions through which light transmits, and they are provided so as to stand on the insulating film 13 at positions corresponding to the light blocking members 42, respectively. By the presence of the partition walls 14, the non-polar liquid 15 is prevented from being moved (flowing out) to any of adjacent other liquid optical elements 1. The partition wall 14 is preferably made of a material which exhibits hydrophilicity for the polar liquid 16 and would not dissolve into either of the non-polar liquid 15 and the polar liquid 16; for example, an epoxy system resin, an acrylic resin or the like. Alternatively, it is also preferable to cover the surface of the partition wall 14 with a thin film made of the material described above. By adopting such a structure, the shape of the non-polar liquid 15 can be stabilized and also flowing-out of the non-polar liquid 15 can be more reliably avoided.

The non-polar liquid 15 preferably has a capacitance sufficient to the extent that the entire surface of the insulating film 13 in each of the liquid optical elements 1 is covered with the non-polar liquid 15 when no voltage is applied across the lower electrode 12 and the upper electrode 17. It is noted that in the second embodiment, the polar liquid 16 is transparent, while the non-polar liquid 15 is colored with a pigment or dye that absorbs light of a predetermined wavelength (for example, visible light) to be opaque.

The control section 20 applies a predetermined voltage across the lower electrode 12 and the upper electrode 17 in accordance with manipulation of the switch 21 and voltage control of the power source 22. At this process, the driving element(s) 41 of the specific liquid optical element(s) 1 can be selected and driven by a gate driver (not shown).

### <Operation of Liquid Optical Element Array>

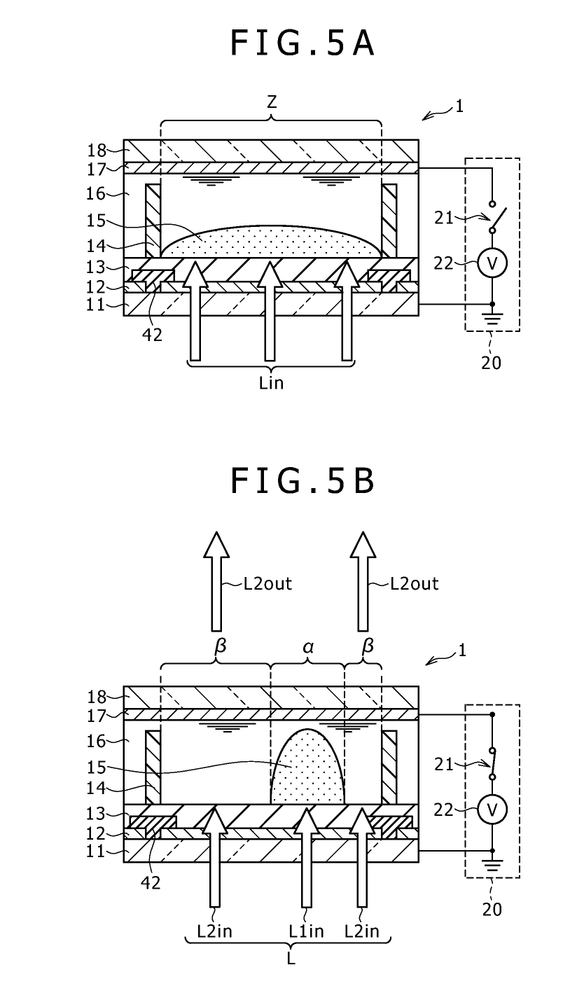

Next, an operation of the liquid optical element array 2 structured in the manner described above will be described with reference to FIGS. 5A and 5B. FIGS. 5A and 5B are enlarged cross sectional views of an arbitrary liquid optical element 1 in the liquid optical element array 2.

Firstly, when the switch 21 in the control section 20 is disconnected and no voltage is applied across the lower electrode 12 and the upper electrode 17, for example, as shown in FIG. 5A, the non-polar liquid 15 spreads so as to cover the entire cell regions Z. Therefore, incident light Lin from the outside, for example, radiated from the side of the lower substrate 11 is blocked by the colored non-polar liquid 15. Here, since the light blocking members 42 are provided, it is possible to suppress leakage of light transmitted through the inside of the partition wall 14 or light from an adjacent liquid optical element 1. In addition, the incident light Lin can be reliably blocked at the peripheral portion of the liquid optical element 1 as well where the thickness of the non-polar liquid 15 is relatively thin. Therefore, a state is provided in which the incident light Lin does not leak to the opposite side (the upper substrate 18 side) at all. On the other hand, when the switch 21 in the control section 20 is turned ON to apply a voltage across the lower electrode 12 and the upper electrode 17, for example, as shown in FIG. 5B, the polar liquid 16 comes into contact with the insulating film 13, and the non-polar liquid 15 concentrates to an arbitrary region α of the liquid optical element 1. For this reason, for example, of the incident light Lin radiated from the outside from the side of the lower substrate 11, the part of the light L1in incident on the region α is blocked by the non-polar liquid 15, whereas the remaining light L2in incident on a region β is transmitted to the opposite side (the upper substrate 18 side) to be emitted as transmitted light Lout. In this case as well, the leakage of the light from both the partition walls 14 and adjacent other liquid optical elements 1 can be reliably suppressed by the presence of the light blocking members 42. Therefore, the transmittance is stabilized. It is noted that such a behavior of the non-polar liquid 15 happens due to a change in wettability of the insulating film 13 for the polar liquid 16 caused by application of a voltage. Specifically, since electric charges are accumulated on the surface of the hydrophobic insulating film 13 when a voltage is applied across the lower electrode 12 and the upper electrode 17, the polar liquid 16 having polarity is drawn toward the hydrophobic insulating film 13 by the Coulomb's force of the electric charges thus accumulated. It can be considered that for this reason the non-polar liquid 15 is moved (deformed) so as to be excluded from the surface of the hydrophobic insulating film 13 by the polar liquid 16 and as a result, is concentrated on the arbitrary region α.

It is noted that although FIG. 5B shows the state in which the maximum transmittance (maximum aperture ratio) is obtained, the size of the non-polar liquid 15 can also be controlled by adjusting the applied voltage, thereby obtaining an arbitrary transmitted light intensity (transmittance) as well.

### <Effects of Liquid Optical Element Array>

As described above, in the liquid optical element array 2 of the second embodiment, the surface of the lower electrode 12 of each of the liquid optical elements 1 is covered with the insulating film 13 in which the dielectric layer 131, the ion barrier layer 132, and the water repellent layer 133 are laminated in this order similarly to the case of the first embodiment. As a result, it is possible to obtain the same effects as those of the first embodiment.

In addition, in the second embodiment, since the non-polar liquid 15 is colored, light can be selectively transmitted through the liquid optical element 1 by utilizing the change in the shape of the interface between the non-polar liquid 15 and the polar liquid 16 owing to presence or absence of the applied voltage. In this case, since the light blocking member 42 is disposed in the region corresponding to each of the peripheral portion and the partition wall 14 of the liquid optical element 1, it is possible to reliably suppress the light leakage from the boundary between the peripheral portion or the partition wall 14 and the insulating film 13 of the liquid optical element 1 when no voltage is applied. Therefore, it is possible to increase the difference in transmittance caused by presence or absence of the applied voltage, and thus it is possible to obtain a higher contrast. Moreover, the lower electrodes 12 extend over the entire surface of the respective liquid optical elements 1. Therefore, in the phase of the voltage application, since the non-polar liquid 15 is quickly deformed without being separated into plural parts, it is possible to obtain excellent responsibility and it is also possible to suppress development of hysteresis in transmittance.

### 3. THIRD EMBODIMENT

### Display Device

### <Configuration of Display Device>

Next, a display device according to a third embodiment of the present disclosure using a liquid optical element array 2 will be descried with reference to FIG. 6. FIG. 6 is a schematic view showing a structure within a horizontal surface of the display device according to the third embodiment of the present disclosure. It is noted that in the third embodiment, constituent elements that are substantially the same as those described in the first embodiment are designated by the same reference numerals or symbols, respectively, and a description thereof is suitably omitted here for the sake of simplicity.

As shown in FIG. 6, the display device includes a display unit 50, and a wave-front conversion-deflecting unit 60 as the liquid optical element array 2 in this order from the side of a light source (not shown). In this case, the traveling direction of light from the light source is set as the Z-axis direction, the horizontal direction is set as the X-axis direction, and the vertical direction is set as the Y-axis direction.

The display unit 50 is a color liquid crystal display device which serves to generate a two-dimensional display image corresponding to a video signal and emits a display image light by, for example, radiating a light from a backlight BL. The display unit 50 has a configuration in which a glass substrate 51, plural display pixels 52 (52L and 52R) each containing a pixel electrode and a liquid crystal layer, and a glass substrate 53 are laminated in order from the side of the light source. The glass substrate 51 and the glass substrate 53 are both transparent, and one of the glass substrate 51 and the glass substrate 53 is provided with a color filter, for example, having colored layers corresponding to Red (R), Green (G), and Blue (B), respectively. Therefore, the display pixels 52 are classified to display pixels R-52 for displaying red, display pixels G-52 for displaying green, and display pixels B-52 for displaying blue. In the display unit 50, the display panels R-52, the display pixels G-52, and the display pixel B-52s are repetitively disposed in order in the X-axis direction, while display pixels 52 of the same color are arranged in the Y-axis direction. The display pixels 52 are further classified into a part for emitting display image light forming an image for the left eye, and a part for emitting display image light forming an image for the right eye, and these parts are disposed alternately in the X-axis direction. In FIG. 6, the display pixels 52 for emitting the display pixel light for the left eye is represented as display pixels 52L and the display pixel 52 for emitting the display pixel light for the right eye is represented as display pixels 52R.

In the wave-front conversion-deflecting unit 60, for example, a plurality of liquid optical elements 1A are disposed in the X-axis direction in an array, such that each of the liquid optical elements 1A corresponds to a set of display pixels 52L and 52R adjacent to each other in the X-axis direction. The wave-front conversion-deflecting unit 60 executes both of wave-front conversion processing and deflecting processing for the display image light emitted from the display unit 50. Specifically, in the wave-front conversion-deflecting unit 60, each of the liquid optical elements 1A corresponding to the display pixels 52, respectively, functions as a cylindrical lens. That is to say, the wave-front conversion-deflecting unit 60 functions as a lenticular lens as a whole. Therefore, the wave surfaces of the display image light from the display pixels 52L and 52R are collectively converted into wave surfaces having a predetermined curvature with a group of display pixels 52 arranged in the vertical direction (in Y-axis direction) serving as one unit. In the wave-front conversion-deflecting unit 60, the display image light can also be collectively deflected within the horizontal surface (within the XZ-plane) as appropriate.

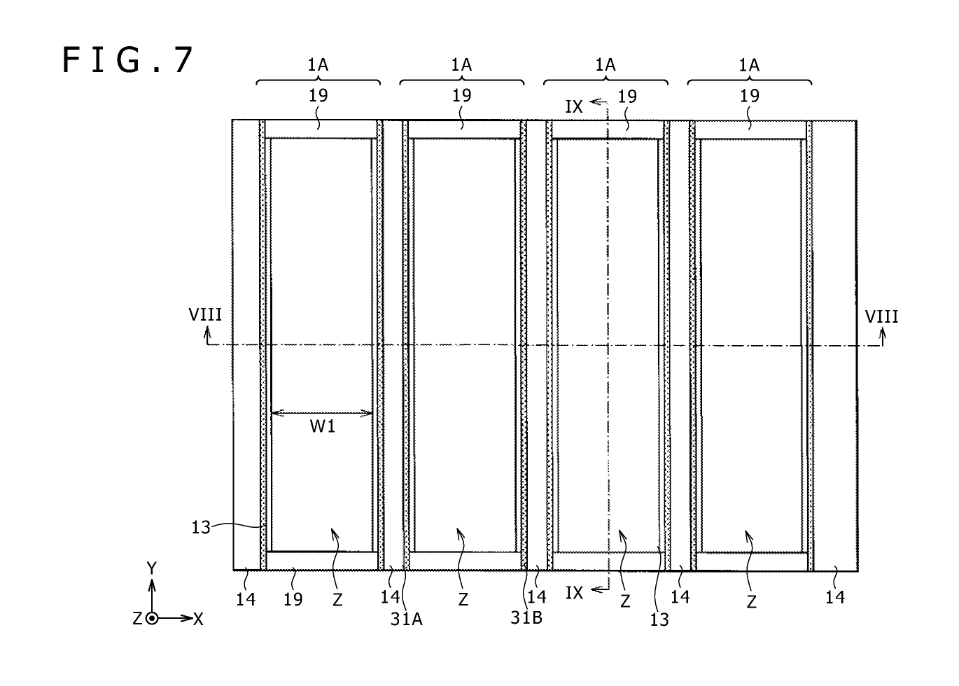

A concrete structure of the wave-front conversion-deflecting unit 60 will be described with reference to FIGS. 7 to 9.

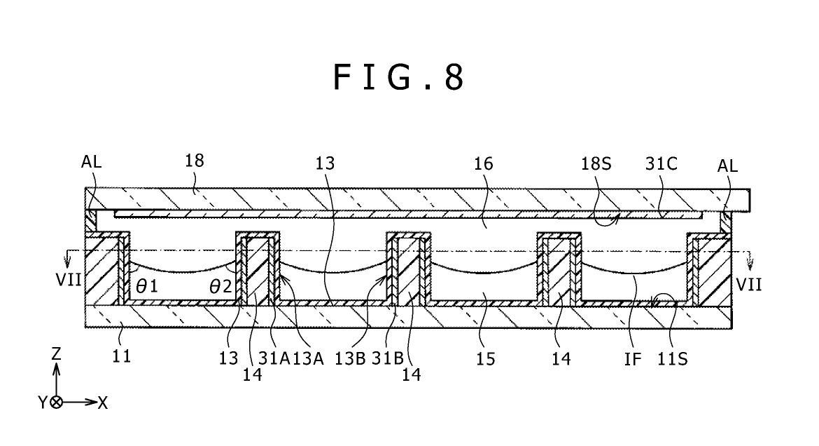

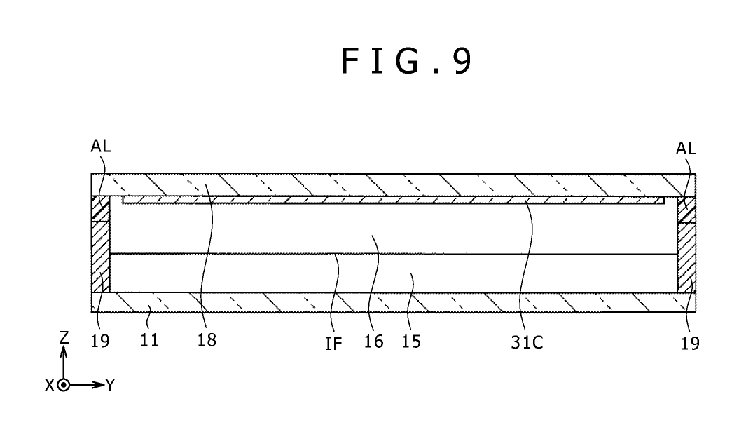

FIG. 7 is an enlarged cross sectional view of the wave-front conversion-deflecting unit 60 parallel to an XY-plane which is orthogonal to the traveling direction of the display image light, illustrating main portions thereof. FIG. 8 is a cross sectional view taken along line VIII-VIII of FIG. 7. FIG. 9 is a cross sectional view taken along line IX-IX of FIG. 7. In addition, FIG. 7 corresponds to a cross section taken along line VII-VII shown in FIG. 8 and viewed in the direction of the arrow of the line.

As shown in FIGS. 7 to 9, the wave-front conversion-deflecting unit 60 includes the lower substrate 11 and the upper substrate 18 which are disposed so as to face each other, and the sidewalls 19 (refer to FIGS. 7 and 9) and the partition walls 14. The sidewalls 19 and the partition walls 14 are erected from the inner surface 11S of the lower substrate 11, and they support the upper substrate 18 via an adhesive layer AL. In the wave-front conversion-deflecting unit 60, plural liquid optical elements 1A including the cell regions Z defined by the plural partition walls 14 extending in the Y-axis direction are arranged in the X-axis direction, and thus compose the liquid optical element array 2 as a whole. The liquid optical elements 1A contain two kinds of liquids (the non-polar liquid 15 and the polar liquid 16) that have different refractive indexes, and provide the optical operations such as deflection, refraction, and the like for an incident light beam.

Plural partition walls 14 which partition the space region over the lower substrate 11 into plural liquid optical elements 1A are erected from the inner surface 11S of the lower substrate 11. The plural partition walls 14, as described above, each extend in the Y-axis direction, and together with the sidewalls 19, form plural liquid optical elements 1A having rectangular planar shapes and corresponding to a group of display pixels 52 arranged in the Y-axis direction. That is to say, the sidewalls 19 are structured so as to surround the plural cell regions Z together with the partition walls 14 by connecting the ends of the plural partition walls 14 on one side and the other as well. The non-polar liquid 15 is held in each of the spaces (the cell regions Z) partitioned by the partition walls 14. That is to say, the non-polar liquid 15 is prevented from moving (flowing out) to any of adjacent other cell regions Z by the presence of the partition walls 14. It is noted that the lower substrate 11 and the partition walls 14 may be made of the same kind of transparent plastic material and thus may be formed by casting.

The side faces of each of the partition walls 14 are provided with a first electrode 31A and a second electrode 31B, respectively, such that the two electrodes face each other. In addition to a transparent conductive material such as indium tin oxide (ITO) or zinc oxide (ZnO), any other suitable conductive material such as a metallic material such as copper (Cu), carbon (C) or conductive polymer can be employed as a material for the first and second electrodes 31A and 31B. Each of the first and second electrodes 31A and 31B continuously extends from one end to the other end of the partition wall 14 without interruption. The first and second electrodes 31A and 31B are connected to an external power source (not shown) through a signal line (not shown) buried in the lower substrate 11 and a control section. The control section can set electric potentials of predetermined magnitudes to the first electrode 31A and the second electrode 31B. Pads (not shown) are formed in both ends of each of the first and second electrodes 31A and 31B and are connected to the external power source (not shown). The first and second electrodes 31A and 31B are tightly covered with the insulating film 13. The insulating film 13 may also be formed so as to not only cover the first and second electrodes 31A and 31B, but also entirely cover the partition walls 14 and the lower substrate 11. Incidentally, the upper ends of the partition walls 14, or the insulating film 13 covering those are preferably parted from the upper substrate 18 and a third electrode 31C which will be described later. In FIG. 9, an illustration of the insulating film 13 is omitted for the sake of convenience.

The third electrode 31C is provided on an inner surface 18S of the upper electrode 18 facing the lower substrate 11. The third electrode 31C, for example, is made of a transparent conductive material such as ITO or ZnO, and it functions as a grounding electrode. It is noted that in FIG. 7, an illustration of the upper substrate 18 and the third electrode 31C is omitted for the sake of convenience.

Both the non-polar liquid 15 and the polar liquid 16 are enclosed within the space region completely sealed by the lower substrate 11, the upper substrate 18, the sidewalls 19, and the partition walls 14. The non-polar liquid 15 and the polar liquid 16 exist in a state where the two are separated from each other in the closed space without dissolving, and form an interface IF between them. Because the non-polar liquid 15 and the polar liquid 16 are both transparent, light transmitted through the interface IF will be refracted in accordance with its incident angle and the refractive indices of the non-polar liquid 15 and the polar liquid 16.

Preferably, the non-polar liquid 15 has a capacitance sufficient to the extent that the non-polar liquid 15 covers the entire lower substrate 11 (the entire insulating film 13) when no voltage is applied across the first electrode 31A and the second electrode 31B.

On the other hand, when a voltage is applied across the first electrode 31A and the second electrode 31B, the wettability of the polar liquid 16 to the inner surfaces 13A and 13B (the contact angle between the polar liquid 16 and the inner surfaces 13A and 13B) largely changes as compared with that of the non-polar liquid 15. The polar liquid 16 is in contact with the third electrode 31C serving as the grounding electrode.

It is preferable that the interval of the partition walls 14 arranged in the X-axis direction (more strictly, the interval W1 (refer to FIG. 7) between the sheets of the insulating film 13 covering two partition walls 14 adjacent in the X-axis direction) is a length equal to or shorter than a capillary length K⁻¹ expressed by Expression (2):

K⁻¹={Δγ/(Δρ×g)}^{0.5} (2)

where K⁻¹ is a capillary length (mm), Δγ is an interfacial tension (mN/m) between the polar liquid and the non-polar liquid, Δρ is a density difference (g/cm³) between the polar liquid and the non-polar liquid, and g is the gravitational acceleration (m/s²). When the interval is set as such, the non-polar liquid 15 and the polar liquid 16 can be stably held in their initial positions (the positions shown in FIG. 8). The reason for this is because as both the non-polar liquid 15 and the polar liquid 16 contact with the insulating film 13 covering the partition walls 14, the interfacial tension at the contact interface acts on both the non-polar liquid 15 and the polar liquid 16. The capillary length K⁻¹ stated here means the maximum length at which the influence of gravity on the interfacial tension generated between the non-polar liquid 15 and the polar liquid 16 can be perfectly disregarded. Therefore, when the interval W1 fulfills Expression (2), both of the non-polar liquid 15 and the polar liquid 16 are held very stably in their initial positions (the positions shown in FIG. 8) without being influenced by the pose of the wave-front conversion-deflecting unit 60.

In each of the liquid optical elements 1A, in a state in which no voltage is applied across the first and second electrodes 31A and 31B (when the electric potentials of the first and second electrodes 31A and 31B are both zero), as shown in FIG. 8, the interface IF exhibits a convex-like curved surface from the side of the polar liquid 16 toward the non-polar liquid 15. The curvature of the interface IF at this time is constant in the Y-axis direction, and thus each of the liquid optical elements 1A functions as a cylindrical lens. In addition, the curvature of the interface IF becomes maximum in this state (in a state in which no voltage is applied across the first and second electrodes 31A and 31B). A contact angle θ1 of the non-polar liquid 15 made with the inner surface 13A, and a contact angle θ2 of the non-polar liquid 15 made with the inner surface 13B can be each adjusted by, for example, selecting the kind of material for the insulating film 13. Here, when the non-polar liquid 15 has a larger refractive index than that of the polar liquid 16, the liquid optical element 1A exercises a negative refracting power. On the other hand, when the non-polar liquid 15 has a smaller refractive index than that of the polar liquid 16, the liquid optical element 1A exercises a positive refracting power. For example, when the non-polar liquid 15 is a hydrocarbon system material or silicon oil, and the polar liquid 16 is water or an electrolyte solution, the liquid optical element 1A exercises a negative refracting power.

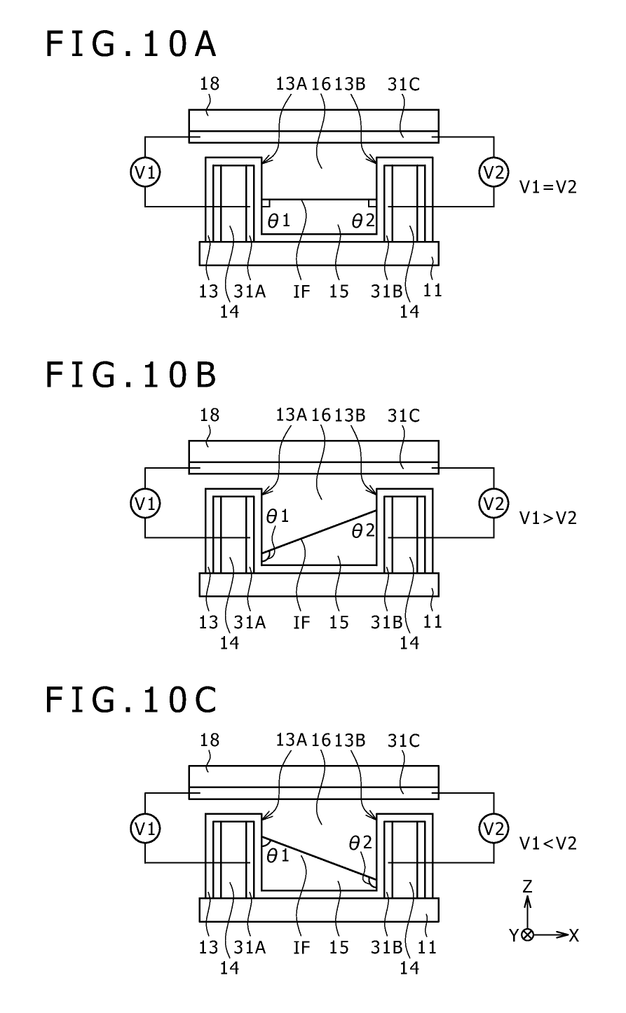

When a voltage is applied across the first and second electrodes 31A and 31B, the curvature of the interface IF becomes small. When the applied voltage reaches a certain voltage or more, the interface IF becomes a flat surface as shown in FIGS. 10A to 10C, for example. FIG. 10A shows the case where the electric potential of the first electrode 31A (referred to as V1), and the electric potential of the second electrode 31B (referred to as V2) are equal to each other (V1=V2). In this case, for example, each of the contact angles θ1 and θ2 becomes a right angle (90°). In this case, light incident on the liquid optical element 1A will be transmitted through the interface IF and emitted from the liquid optical element 1A directly without receiving optical operations such as convergence, divergence and deflection at the interface IF.

When the electric potential V1 and the electric potential V2 are different from each other (V1≠V2), for example, as shown in FIG. 10B or 10C, the interface IF becomes a flat surface (a surface parallel with the Y-axis) inclined with respect to the X-axis and the Z-axis (θ1≠θ2). Specifically, when the electric potential V1 is larger than the electric potential V2 (V1>V2), as shown in FIG. 10B, the contact angle θ1 becomes larger than the contact angle θ2 (θ1>θ2). Contrary to this, when the electric potential V2 is larger than the electric potential V1 (V1<V2), as shown in FIG. 10C, the contact angle θ2 becomes larger than the contact angle θ1 (θ1<θ2). In these cases (V1≠V2), for example, light incident on the liquid optical element 1A traveling parallel with the first and second electrodes 31A and 31B will be refracted and deflected within the XZ-plane surface at the interface IF. Therefore, the incident light can be deflected at a predetermined direction within the XZ-plane surface by adjusting the magnitudes of the electric potential V1 and the electric potential V2.

Incidentally, the above phenomenon (the variation of the contact angles θ1 and θ2 by application of a voltage) is considered to occur as follows. That is to say, application of a voltage makes electric charges accumulate on the inner surfaces 13A and 13B, and the polar liquid 16 having a polarity is drawn toward the hydrophobic insulating film 13 by the Coulomb's force of the electric charges thus accumulated. Then, the area in which the polar liquid 16 contacts with the inner surfaces 13A and 13B increases, while the polar liquid 15 is moved (deformed) so that its portions in contact with the inner surfaces 13A and 13B are excluded by the polar liquid 16. As a result, the interface IF becomes close in shape to a flat surface.

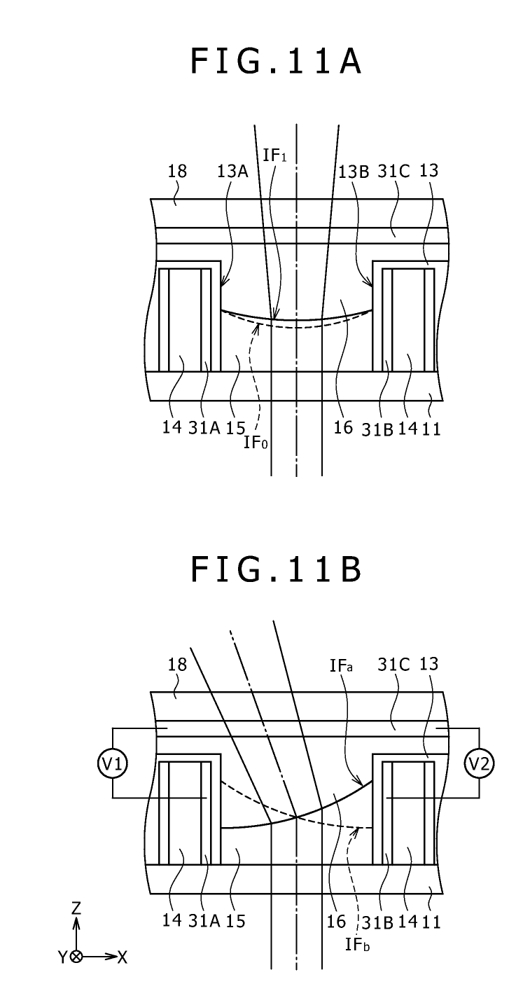

In addition, the curvature of the interface IF is changed by adjusting the magnitudes of the electric potential V1 and the electric potential V2. For example, if each of the electric potential V1 and the electric potential V2 (V1=V2) has a lower value than that of an electric potential Vmax at which the interface IF becomes the horizontal surface, as shown in FIG. 11A, there will be obtained an interface IF₁ (indicated by the solid line) whose curvature is smaller than that of an interface IF₀ (indicated by the broken line) when the electric potential, V1 and the electric potential V2 are zero. Therefore, the refracting power exercised on the light transmitted through the interface IF by the liquid optical element 1A can be adjusted by changing the magnitudes of the electric potential V1 and the electric potential V2. That is to say, the liquid optical element 1A functions as a variable-focal-length lens. In addition, when the electric potential V1 and the electric potential V2 become different in magnitude from each other (V1≠V2), a state is provided in which the interface IF becomes an inclined state with an appropriate curvature. For example, when the electric potential V1 is larger than the electric potential V2 (V1>V2), an interface IFa indicated by a solid line in FIG. 11B is formed. On the other hand, when the electric potential V2 is larger than the electric potential V1 (V2>V1), an interface IFb indicated by a broken line in FIG. 11B is formed. Therefore, by adjusting the magnitudes of the electric potential V1 and the electric potential V2, the liquid optical element 1A can exercise a suitable refracting power on the incident light and deflect the light in a predetermined direction. Incidentally, FIGS. 11A and 11B show the changes in the incident light when the interfaces IF₁ and IFa are formed in the case where the non-polar liquid 15 has a larger refractive index than that of the polar liquid 16, and the liquid optical element 1A exercises a negative refracting power.

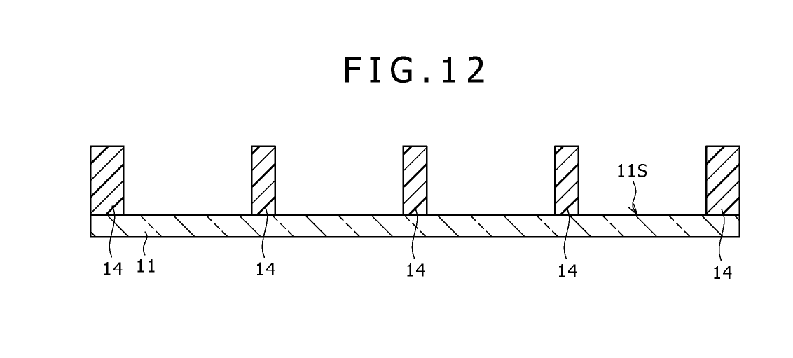

Next, a method of manufacturing the wave-front conversion-deflecting unit 60 will be described with reference to schematic cross sectional views shown in FIGS. 12 to 14.

Firstly, after the lower substrate 11 has been prepared, as shown in FIG. 12, the partition walls 14 are formed at predetermined positions on one surface (the inner surface 11S) of the lower substrate 11. Specifically, after an appropriate resin has been applied onto the inner surface 11S so as to have a uniform thickness as possible by, for example, the spin-coating method, selective exposure is carried out utilizing the photolithography method, thereby patterning the resin. Alternatively, the planar substrate 11 and the partition walls 14 may be formed integrally from the same kind of material by integral molding using a metallic mold having a certain shape. In addition thereto, the planar substrate 11 and the partition walls 14 can also be formed through injection molding, the thermal press molding, the transfer molding using a film material, the photoreplication process (2P) method, and so on.

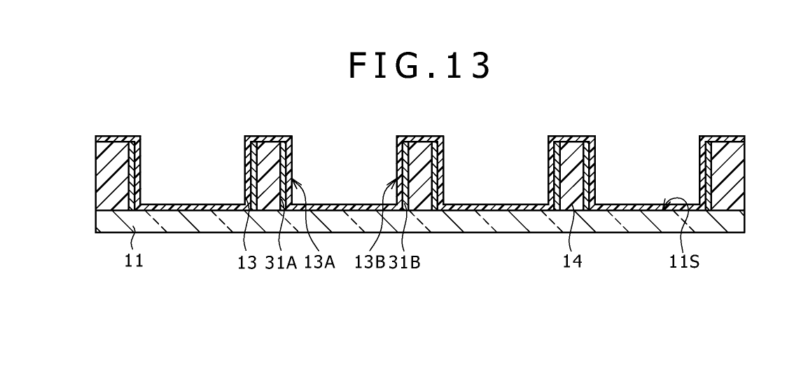

Next, as shown in FIG. 13, the first and second electrodes 31A and 31B made of a suitable conductive material are formed on the side faces of the partition walls 14, respectively. In this case, for example, it is possible to utilize the technique such as the photolithography method, the mask transfer, the inkjet drawing or the like. In addition, the insulating film 13 is formed so as to cover at least the first and second electrodes 31A and 31B. In formation of the insulating film 13, the dielectric layer 131 is preferably formed by utilizing the ALD method, the sputtering method or the CVD method. The ion barrier layer 132 is preferably formed by utilizing the vacuum evaporation method or the like, and the water repellent layer 133 is preferably formed by utilizing any of the various kinds of evaporation methods, the dipping method, the spin coating method or the like. It is noted that the insulating film 13 may also be formed so as to cover the inner surface 11S and the upper surface of each of the partition walls 14.

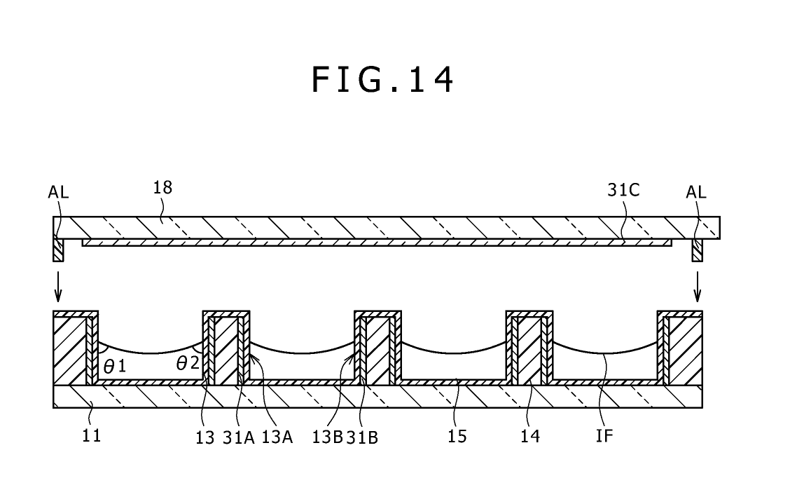

Subsequently, as shown in FIG. 14, the non-polar liquid 15 is either injected or dropped into each of the spaces obtained through the partition by the partition walls 14. After that, the upper substrate 18 provided with the third electrode 31C is prepared, and the lower substrate 11 and the upper substrate 18 are disposed so as to face each other and so as to hold the predetermined space between them. In this case, the adhesive layer AL is provided along the outer edges of the area of the upper substrate 18 in which the lower substrate 11 and the upper substrate 18 are to be superposed on each other. Also, the upper substrate 18, and the sidewall 19 (not shown in this case) and the partition walls 14 of the lower substrate 11 are fixed to each other through the adhesive layer AL. An injection hole (not shown) is formed at a portion of the adhesive layer AL. Finally, after the polar liquid 16 has been filled in the spaces surrounded by the lower substrate 11, the sidewalls 19, the partition walls 14, and the upper substrate 18 through the injection hole, the injection hole is sealed. By adopting the procedures described above, it is possible to simply manufacture the wave-front conversion-deflecting unit 60 including plural liquid optical elements 1A having excellent responsibility.

### <Operation of Display Device>

In the display device, as shown in FIG. 6, when a video signal is inputted to the display unit 50, the display image light I-L for the left eye is emitted from the display pixel 52L, and the display image light I-R for the right eye is emitted from the display pixel 52R. Each of the rays of display image light I-L and I-R enters the liquid optical element 1A. In the liquid optical element 1A, a voltage of such a suitable value is applied across the first and second electrodes 31A and 31B that the focal distance of the liquid optical element 1A, for example, becomes equal to a distance obtained by converting the refractive index of the portion between the first and second electrodes 31A and 31B, and the interface IF into a refractive index of air. It is noted that the focal length of the liquid optical element 1A may be increased or decreased depending on the position of an observer. Emission angles of the display image light rays I-L and I-R which are emitted from the display pixel 52L and the display pixel 52R, respectively, are selected based on the operation of the cylindrical lens formed by the interface IF between the non-polar liquid 15 and the polar liquid 16 in the liquid optical element 1A. Thus, as shown in FIG. 6, the display image light I-L enters the left eye 10L of the observer, and the display image light I-R enters the right eye 10R of the observer. As a result, the observer can observe a stereoscopic image.

In addition, if the interface IF is formed to have a flat surface (refer to FIG. 10A) in the liquid optical element 1A, and thus the wave-front conversion for the display image lights I-L and I-R is not carried out, displaying of a two-dimensional image having high resolution can be achieved.

### <Effects of Display Device>

As described above, in the wave-front conversion-deflecting unit 60 in the third embodiment, the first and second electrodes 31A and 31B provided over the partition walls 14 are each covered with the insulating film 13, in which the dielectric layer 131, the ion barrier layer 132, and the water repellent layer 133 are laminated in this order similarly to the case of the first embodiment. As a result, it is possible to obtain the same effects as those in the first embodiment described above. That is to say, in each of the liquid optical elements 1A, the drive voltage can be reduced due to thinning of the insulating film 13 while ensuring sufficient insulating property of the insulating film 13, and the stable change of the interface shape can be precisely reproduced. For this reason, according to the display device including the liquid optical elements 1A, precise image display corresponding to the predetermined video signal can be realized.

### 4. FOURTH EMBODIMENT

### Electronic Apparatus

An electronic apparatus according to a fourth embodiment of the present disclosure includes the display device having the display section 50 and the liquid optical element array 2 (the wave-front conversion-deflecting unit 60). As described above, the liquid optical element array 2 includes the lower substrate 11 and the upper substrate 18 disposed so as to face each other, the partition wall 14, the lower electrode 12 and the upper electrode 17, the insulating film 13, the third electrode 31C, and the polar liquid 16 and the non-polar liquid 15. The partition wall 14 is erected on the inner surface of the lower substrate 11 facing the upper substrate 18 and it partitions the region over the lower substrate 11 into plural cell regions Z. The lower electrode 12 and the upper electrode 17 are disposed in each of the plural cell regions Z on the wall surfaces of the partition wall 14 so as to face each other. The insulating film 13 includes the dielectric layer 131, the ion barrier layer 132, and the water repellent layer 33 which are laminated in order so as to cover the lower electrode 12 and the upper electrode 17. The third electrode 31C is provided on the inner surface of the upper substrate 18 facing the lower substrate 11. The polar liquid 16 and the non-polar liquid 15 are enclosed between the lower substrate 11 and the third electrode 31C and have refractive indices different from each other. The dielectric layer 131 has a larger permittivity than that of the ion barrier layer 132, the ion barrier layer 132 suppresses permeation of an ion contained in the polar liquid 16, and the water repellent layer 133 exhibits affinity for the non-polar liquid 16.

### 5. EXAMPLES OF APPLICATION

### Examples of Application of Display Device

Next, a description will be given with respect to Examples of Application of the display device of the third embodiment described above.

The display device according to the third embodiment of the present disclosure can be applied to various use applications of electronic apparatuses and the kinds of electronic apparatuses are by no means especially limited. The display device of the third embodiment, for example, can be mounted to the following electronic apparatuses. However, constitutions of electronic apparatuses which will be desired below are merely examples, and thus can be suitably changed.

FIG. 15 shows a configuration of an external appearance of a television apparatus. The television apparatus, for example, includes a video display screen portion 200 as the display device. The video display screen portion 200 includes a front panel 210 and a filter glass 220.

In addition to the television apparatus shown in FIG. 15, the display device of the third embodiment, for example, can be used as a video display portion of a tablet type personal computer (PC), a notebook-size PC, a mobile phone, a digital still camera, a video camera or a car navigation system.

### 6. EXAMPLES OF EXPERIMENT

Hereinafter, concrete Examples of Experiment of the first embodiment of the present disclosure will be described.

### 6-1. Example 1 of Experiment

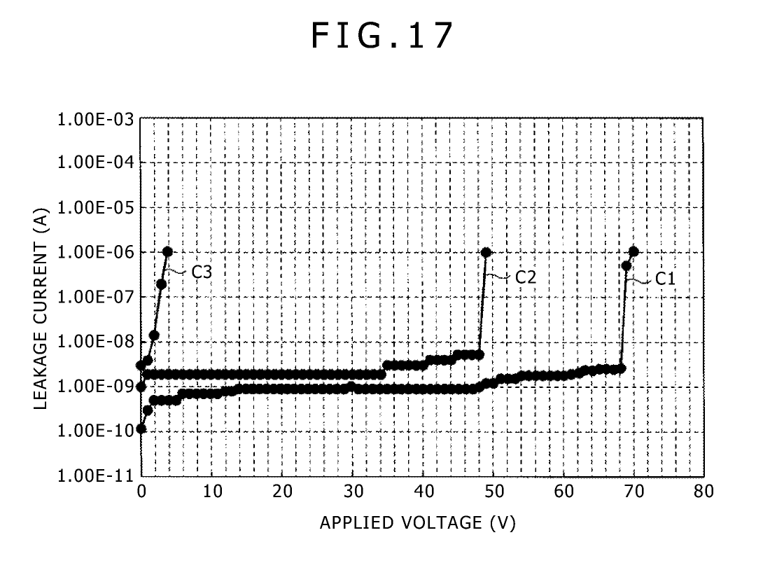

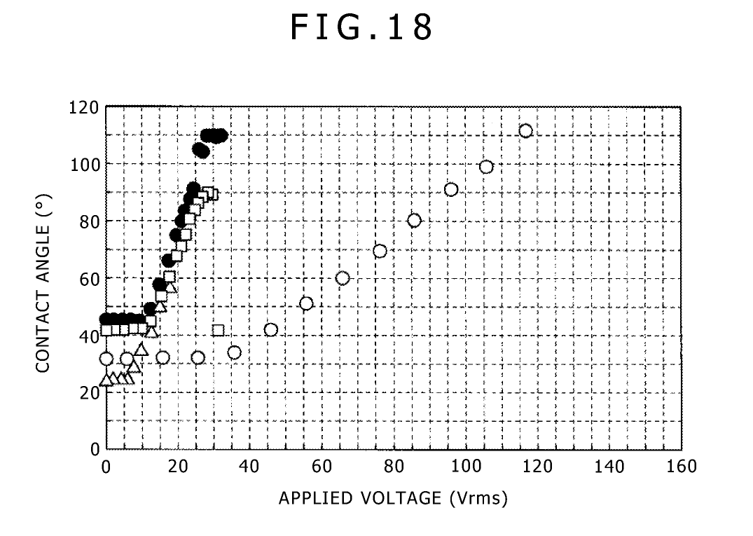

In Example 1 of Experiment, an evaluation of a withstand voltage of an insulating film was carried out. Concretely, a sample schematically shown in FIG. 16 was prepared and a change in a leakage current (A) when a voltage (V) was applied across a lithium chloride liquid solution (a refractive index for a d-line is 1.375) as the polar liquid 16, and the lower electrode 12 was measured. FIG. 17 shows a measurement result (a curved line C1). Here, the lower substrate 11 was composed of a glass substrate, and the lower electrode 12 was made of ITO. Also, the insulating film 13 had a three-layer structure of the dielectric layer 131, the ion barrier layer 132, and the water repellent layer 133.

Specifically, a dielectric layer 131 made of Al₂O₃ was formed by utilizing the ALD method so as to have a thickness of 50 nm. It is noted that a temperature of the glass substrate (the lower substrate 11) in this case was suppressed to about 80 to 100° C. by using ozone as an oxidizing agent. In addition, the ion barrier layer 132 was formed by utilizing the vacuum evaporation method using raw dimer powder (manufactured by Parylene Japan K.K.) of parylene C (refer to the chemical formula (2)) so as to have a thickness of 100 nm. More specifically, firstly, after the raw dimer powder had been heated at 150° C. in a heating chamber to be vaporized, the dimer thus vaporized was transported to a pyrolyzing chamber. After that, the dimer steam was further heated up to 680° C. in the pyrolyzing chamber to be pyrolyzed, thereby producing a monomer gas which is rich in responsiveness. Then, the resulting monomer gas was introduced into a deposition chamber in which a vacuum is drawn, so as to contact the gas with a specimen substrate (obtained by forming the lower electrode 12 and the dielectric layer 131 on the lower substrate 11) within the deposition chamber at a room temperature, thereby polymerizing the monomer gas on the surface of the dielectric layer 131. Moreover, as for the water repellent film 133, a film of NANOS (manufactured by T & K inc.), a fluorine-containing compound, was formed to have a thickness of 8 nm.

### 6-2. Example 2 of Experiment

A sample as shown in FIG. 16 which is identical to the sample of Example 1 of Experiment except that no water repellent film 133 is provided was prepared. A measurement result is shown together with the curved line C1 in FIG. 17 (a curved line C2).

### 6-3. Example 3 of Experiment

A sample as shown in FIG. 1 which is identical to the sample of Example 1 of Experiment except that the ion barrier layer 132 and the water repellent film 133 are not provided was prepared. A measurement result is shown together with the curved lines C1 and C2 in FIG. 17 (a curved line C3).

In FIG. 17, the axis of abscissa represents the applied voltage (V) and the axis of ordinate represents the leakage current (A). As shown in FIG. 17, in Example 1 of Experiment (the curved line C1), the highest dielectric breakdown voltage (about 68 V) was obtained. In Example 2 of Experiment (the curved line C2), by providing the ion barrier layer 132, the voltage withstanding characteristics are improved as compared with the case where the insulating film 13 is composed of only the dielectric layer 131 (Example 3 of Experiment (the curved line C3)). It was confirmed that by forming the water repellent layer 133 as with the first embodiment of the present disclosure, further improvement in the voltage withstanding characteristics can be realized. It is noted that even in cases where the dielectric layer 131 is made of any of the materials such as Ta₂O₅, ZrO₂, ZnO₂, TiO₂, MgO, and HfO₂, the same effects as those of the foregoing are obtained. In addition, even in the case where the ion barrier layer 132 is made of any of parylene N expressed by the chemical formula (1), and parylene D expressed by the chemical formula (3), the same effects as those of the foregoing are obtained.

### 6-4. Example 4 of Experiment

In Example 4 of Experiment, an evaluation was carried out with respect to a relationship between an applied voltage and a contact angle. Specifically, a sample of the liquid optical element 1 shown in FIGS. 1A and 1B was prepared and measurement was performed of an angle which the interface between the non-polar liquid 15 and the polar liquid 16 makes with the surface of the insulating film 13 when the voltage applied across the lower electrode 12 and the upper electrode 17 was changed. FIG. 18 shows the result of the measurement (indicated by plot of marks “”). Here, methylphenyl silicon oil (having refractive index of 1.556 for the d-line) was used as the non-polar liquid 15, and a lithium chloride solution (having refractive index of 1.375 for the d-line) was used as the polar liquid 16. In addition, the upper electrode 17 and the upper substrate 18 were made of the same materials as those of the lower electrode 12 and the lower substrate 11, respectively. Except for the points described above, the sample of Example 4 of Experiment had the same structure as that of Example 1 of Experiment

### 6-5. Example 5 of Experiment

A sample as shown in FIG. 1 which is identical to that of Example 4 of Experiment except that no water repellent film 133 is provided was prepared. A result of the measurement is shown together with the plot of the marks “” in FIG. 18 (indicated by plot of marks “□”).

### 6-6. Example 6 of Experiment

A sample as shown in FIG. 1 was prepared which is identical to that of Example 4 of Experiment except that only the ion barrier layer 132 is provided as the insulating film with a thickness of 200 nm. A result of the measurement is shown together with the plot of the marks “” and the plot of the marks “□” in FIG. 18 (indicated by plot of marks “Δ”).

### 6-7. Example 7 of Experiment

A sample shown in FIG. 1 was prepared which is identical to that of Example 4 of Experiment except that only the ion barrier 132 is provided as the insulating film with a thickness of 3 μm. A result of the measurement is shown together with the plot of the marks “”, the plot of the marks “□”, and the plot of the marks “Δ” in FIG. 18 (indicated by plot of marks “∘”).

In FIG. 18, the axis of abscissa represents the applied voltage (Vrms), and the axis of ordinate represents the contact angle (°). As shown in FIG. 18, in Example 4 of Experiment, the largest contact angle (°) could be obtained at a relatively low applied voltage (Vrms). Specifically, the contact angle of about 110° was obtained at Vrms=28.7 V. With regard to the initial contact angle, in other words, the contact angle of the period from the state in which no voltage is applied (Vrms=0) to the occurrence of the first change (up to Vrms=10), the contact angle was very stably at about 45°. On the other hand, in Example 5 of Experiment, and Example 6 of Experiment, although changes in the contact angles are observed in the relatively low applied voltage, the maximum values of the contact angles were limited to about 90° and about 60°, respectively. In Example 7 of Experiment, although the contact angle of about 110° was obtained, it was found that application of a high voltage of about 120 Vrms is required. Incidentally, it was confirmed that even in the cases where the dielectric layer 131 was made of any of the materials such as Ta₂O₅, ZrO₂, ZnO₂, TiO₂, MgO, and HfO₂, the same effects as those of the foregoing were obtained. In addition, even in the cases where the ion barrier layer 132 was made of any of parylene N expressed by the chemical formula (1), and parylene D expressed by the chemical formula (3), the same effects as those of the foregoing were obtained.

From the experimental results described above, it was confirmed that using the insulating film having the three-layer structure according to an embodiment of the present disclosure, changes in the interface shape in a broader range can be precisely reproduced even with a low voltage, while ensuring the withstand voltage characteristics.

Although the present disclosure has been described so far by giving some embodiments, the present disclosure is by no means limited to the embodiments described above, and thus various kinds of modifications and alterations can be made. For example, in the third embodiment described above, the converging or diverging operation and the deflecting operation are both exercised by the liquid optical elements 1A in the wave-front conversion-deflecting unit 60. However, a configuration may also be adopted in which a wave-front converting unit and a deflecting unit are individually provided, so that the converging or diverging operation and the deflecting operation are given to the display image light by different devices.

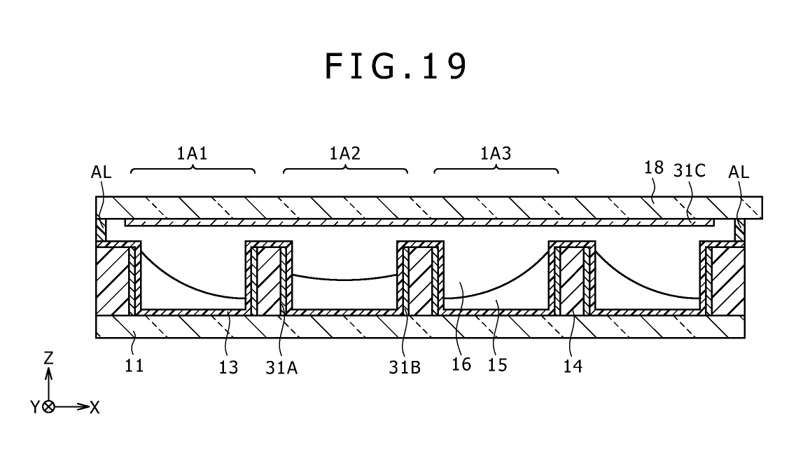

In addition, a configuration may also be adopted in which as shown in FIG. 19, a pair of display pixels 52L and 52R corresponds to a plurality of liquid optical elements 1A, and the plurality of liquid optical elements 1A function as one cylindrical lens in combination. FIG. 19 shows an example of a configuration in which one cylindrical lens is constituted by liquid optical elements 1A1, 1A2, and 1A3.

In addition, although in the third embodiment described above, the color liquid crystal display device using the backlight as the two-dimensional image generating section (display portion) is exemplified, the present disclosure is by no means limited thereto. For example, a display device using an organic EL element, or a plasma display device may also be adopted as the display device.

In addition, applications of the liquid optical element of the present disclosure are not limited to display devices, and the liquid optical element can also be applied to various kinds of devices using an optical operation.

In addition, the present disclosure can also adopt the following constitutions.

(1)

An optical element, including: a first electrode and a second electrode disposed so as to face each other; an insulating film covering a surface of the first electrode facing the second electrode, the insulating film including a dielectric layer, an ion barrier layer, and a water repellent layer laminated in order; and a polar liquid and a non-polar liquid enclosed between the insulating film and the second electrode and having refractive indices different from each other, wherein the dielectric layer has a larger permittivity than that of the ion barrier layer, the ion barrier layer suppresses permeation of an ion contained in the polar liquid, and the water repellent layer is located in an uppermost layer of the insulating film and exhibits an affinity for the non-polar liquid.

(2)

The optical element described in paragraph (1), wherein the ion barrier layer contains therein polymer having a para-xylylene skeleton as a repeating unit.

(3)

The optical element described in paragraph (1) or (2), wherein the water repellent layer contains therein a fluorine-containing resin.

(4)

The optical element described in any one of paragraphs (1) to (3), wherein the dielectric layer contains therein at least one kind of material selected from the group consisting of Al₂O₃, Ta₂O₅, ZrO₂, ZnO₂, TiO₂, MgO, and HfO₂.

(5)

The optical element described in any one of paragraphs (1) to (4), wherein the first electrode is provided on a first substrate located on a side opposite to the insulating film; and the second electrode is provided on a second substrate located on a side opposite to the first electrode.

(6)

The optical element described in paragraph (5), wherein the first substrate is a transparent resin substrate containing therein at least one kind of material selected from the group consisting of polycarbonate (PC), polyethylene terephthalate (PET), polyethylene naphthalate (PEN), polyethersulphone (PES), and polyolefin (PO).

(7)

The optical element described in any one of paragraphs (1) to (6), wherein the second electrode is a grounding electrode.

(8)

An optical element array, including: a first substrate and a second substrate disposed so as to face each other; a partition wall erected on an inner surface of the first substrate facing the second substrate, the partition wall partitioning a region over the first substrate into plural cell regions; a first electrode and a second electrode disposed in each of the plural cell regions on wall surfaces of the partition wall, respectively, so as to face each other; an insulating film covering the first electrode and the second electrode, the insulating film including a dielectric layer, an ion barrier layer, and a water repellent layer laminated in order; a third electrode provided on an inner surface of the second substrate facing the first substrate; and a polar liquid and a non-polar liquid enclosed between the first substrate and the third electrode and having refractive indices different from each other, wherein the dielectric layer has a larger permittivity than that of the ion barrier layer, the ion barrier layer suppresses permeation of an ion contained in the polar liquid, and the water repellent layer exhibits an affinity for the non-polar liquid.

(9)

A display device including a display section and an optical element array, the optical element array including: a first substrate and a second substrate disposed so as to face each other; a partition wall erected on an inner surface of the first substrate facing the second substrate, the partition wall partitioning a region over the first substrate into plural cell regions; a first electrode and a second electrode disposed in each of the plural cell regions on wall surfaces of the partition wall, respectively, so as to face each other; an insulating film covering the first electrode and the second electrode, the insulating film including a dielectric layer, an ion barrier layer, and a water repellent layer laminated in order; a third electrode provided on an inner surface of the second substrate facing the first substrate; and a polar liquid and a non-polar liquid enclosed between the first substrate and the third electrode and having refractive indices different from each other, wherein the dielectric layer has a larger permittivity than that of the ion barrier layer, the ion barrier layer suppresses permeation of an ion contained in the polar liquid, and the water repellent layer exhibits an affinity for the non-polar liquid.

(10)

An electronic apparatus including a display device having a display section and an optical element array, the optical element array including: a first substrate and a second substrate disposed so as to face each other; a partition wall erected on an inner surface of the first substrate facing the second substrate, the partition wall partitioning a region over the first substrate into plural cell regions; a first electrode and a second electrode disposed in each of the plural cell regions on wall surfaces of the partition wall, respectively, so as to face each other; an insulating film covering the first electrode and the second electrode, the insulating film including a dielectric layer, an ion barrier layer, and a water repellent layer laminated in order; a third electrode provided on an inner surface of the second substrate facing the first substrate; and a polar liquid and a non-polar liquid enclosed between the first substrate and the third electrode and having refractive indices different from each other, wherein the dielectric layer has a larger permittivity than that of the ion barrier layer, the ion barrier layer suppresses permeation of an ion contained in the polar liquid, and the water repellent layer exhibits an affinity for the non-polar liquid.

The present disclosure contains subject matter related to that disclosed in Japanese Priority Patent Application JP 2011-173781 filed in the Japan Patent Office on Aug. 9, 2011, the entire content of which is hereby incorporated by reference.

What is claimed is:

1. An optical element, comprising:
a first electrode and a second electrode disposed so as to face each other;
an insulating film covering a surface of said first electrode facing said second electrode, said insulating film including a dielectric layer, an ion barrier layer, and a water repellent layer laminated in order; and
a polar liquid and a non-polar liquid enclosed between said insulating film and said second electrode and having refractive indices different from each other,
wherein said dielectric layer has a larger permittivity than that of said ion barrier layer,
said ion barrier layer suppresses permeation of an ion contained in said polar liquid, and
said water repellent layer is located in an uppermost layer of said insulating film and exhibits an affinity for said non-polar liquid.

2. The optical element according to claim 1, wherein said ion barrier layer contains therein polymer having a para-xylylene skeleton as a repeating unit.

3. The optical element according to claim 1, wherein said water repellent layer contains therein a fluorine-containing resin.

4. The optical element according to claim 1, wherein said dielectric layer contains therein at least one kind of material selected from the group consisting of Al₂O₃, Ta₂O₅, ZrO₂, ZnO₂, TiO₂, MgO, and HfO₂.

5. The optical element according to claim 1, wherein said first electrode is provided on a first substrate located on a side opposite to said insulating film, and
said second electrode is provided on a second substrate located on a side opposite to said first electrode.

6. The optical element according to claim 5, wherein said first substrate is a transparent resin substrate containing therein at least one kind of material selected from the group consisting of polycarbonate (PC), polyethylene terephthalate (PET), polyethylene naphthalate (PEN), polyethersulphone (PES), and polyolefin (PO).

7. The optical element according to claim 1, wherein said second electrode is a grounding electrode.

8. An optical element array, comprising:
a first substrate and a second substrate disposed so as to face each other;
a partition wall erected on an inner surface of said first substrate facing said second substrate, said partition wall partitioning a region over said first substrate into plural cell regions;
a first electrode and a second electrode disposed in each of said plural cell regions on wall surfaces of said partition wall, respectively, so as to face each other;
an insulating film covering said first electrode and said second electrode, said insulating film including
a dielectric layer, an ion barrier layer, and a water repellent layer laminated in order;
a third electrode provided on an inner surface of said second substrate facing said first substrate; and
a polar liquid and a non-polar liquid enclosed between said first substrate and said third electrode and having refractive indices different from each other,
wherein said dielectric layer has a larger permittivity than that of said ion barrier layer,
said ion barrier layer suppresses permeation of an ion contained in said polar liquid, and
said water repellent layer exhibits an affinity for said non-polar liquid.

9. A display device including a display section and an optical element array, said optical element array comprising:
a first substrate and a second substrate disposed so as to face each other;
a partition wall erected on an inner surface of said first substrate facing said second substrate, said partition wall partitioning a region over said first substrate into plural cell regions;
a first electrode and a second electrode disposed in each of said plural cell regions on wall surfaces of said partition wall, respectively, so as to face each other;
an insulating film covering said first electrode and said second electrode, said insulating film including a dielectric layer, an ion barrier layer, and a water repellent layer laminated in order;
a third electrode provided on an inner surface of said second substrate facing said first substrate; and
a polar liquid and a non-polar liquid enclosed between said first substrate and said third electrode and having refractive indices different from each other,
wherein said dielectric layer has a larger permittivity than that of said ion barrier layer,
said ion barrier layer suppresses permeation of an ion contained in said polar liquid, and
said water repellent layer exhibits an affinity for said non-polar liquid.

10. An electronic apparatus including a display device having a display section and an optical element array, said optical element array comprising:
a first substrate and a second substrate disposed so as to face each other;
a partition wall erected on an inner surface of said first substrate facing said second substrate, said partition wall partitioning a region over said first substrate into plural cell regions;
a first electrode and a second electrode disposed in each of said plural cell regions on wall surfaces of said partition wall, respectively, so as to face each other;
an insulating film covering said first electrode and said second electrode, said insulating film including a dielectric layer, an ion barrier layer, and a water repellent layer laminated in order;
a third electrode provided on an inner surface of said second substrate facing said first substrate; and
a polar liquid and a non-polar liquid enclosed between said first substrate and said third electrode and having refractive indices different from each other,
wherein said dielectric layer has a larger permittivity than that of said ion barrier layer,
said ion barrier layer suppresses permeation of an ion contained in said polar liquid, and
said water repellent layer exhibits an affinity for said non-polar liquid.
